(19) United States
(12) Patent Application Publication
(10) Pub. No.: US 2017/0345331 A1
(43) Pub. Date: Nov. 30, 2017

(54) Habit Bracelet

(71) Applicant: Chelsea Ann Hall, Ammon, ID (US)

(72) Inventor: Chelsea Ann Hall, Ammon, ID (US)

(21) Appl. No.: 15/165,280

(22) Filed: May 26, 2016

(51) Int. Cl. G09B 19/00; A44C 5/00

(52) U.S. Cl. CPC G09B 19/00; A44C 5/0015

(57) ABSTRACT

A habit bracelet fabricated from a flexible material such as silicone or rubber. The bracelet has the a plurality of removable elements such as for example, break-off and/or punch-out elements. The removable elements can have a variety of shapes, such as, for example, triangular, square, rectangular, circular, semicircular, pentagonal, trapezoidal, star-shaped, and/or heart-shaped. In various embodiments, the bracelet has 21, 42, or 66 removable elements corresponding to a number of days a person wishes to perform a targeted behavior.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### FIELD

The present disclosure relates generally to bracelets and more particularly pertains to bracelets that provide functionality to aid users in the formation of habits.

### BACKGROUND

Some say that it takes 6 weeks to form a new habit. Others estimate shorter or longer periods such as, for example, 21 days or 66 days. Perhaps the greatest challenge in forming a new habit is to perform a targeted behavior consistently every day until the habit is formed and becomes second nature.

### SUMMARY

In various embodiments, the present disclosure relates to habit bracelets fabricated from a flexible material such as silicone or rubber. The bracelets have a plurality of removable elements, for example, such as break-off and/or punch-out elements. The removable elements can have a variety of shapes such as, for example, triangular, square, rectangular, circular, semicircular, pentagonal, trapezoidal, star-shaped, and/or heart-shaped.

In various embodiments, such bracelets can be used to support the formation of a habit. In an embodiment a person selects the targeted behavior. The person then puts on a habit bracelet that has a number of removable elements corresponding to a number of days the user will perform the targeted behavior. The person then performs the targeted behavior daily, and after performing the targeted behavior, removes one of the removable elements from the bracelet. The user continues to wear the habit bracelet and perform the targeted behavior daily until all of the removable elements have been removed from the bracelet.

Various other embodiments of habit bracelets according to the present disclosure are described in detail below.

### BRIEF DESCRIPTION OF THE DRAWINGS

The embodiments are illustrated by way of example and not limitation in the figures of the accompanying drawings in which like references indicate similar elements.

FIG. 1 shows an embodiment of a habit bracelet with forty-two triangular break-off elements.

FIG. 2 shows an embodiment of the habit bracelet with twenty-one punch-out elements.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

As used herein, the term “break-off element” should be understood to refer to, generally, a portion of a larger structure that is configured to be broken off from the larger structure. No particular geometry is implied. The break-off element could be, for example, triangular, square, rectangular, circular, semicircular, pentagonal, trapezoidal, star-shaped, or heart-shaped. In various embodiments, one or more sides of a break-off element of a larger structure are located adjacent to, or comprise a portion, of an edge of the larger structure.

As used herein, the term “punch-out element” should be understood to refer to, generally, a portion of a larger structure that is configured to be punched or pushed out from the larger structure. No particular geometry is implied. The punch-out element could be, for example, triangular, square, rectangular, circular, pentagonal, trapezoidal star-shaped, or heart-shaped. In various embodiments, no side of a punch-out element of a larger structure comprises a portion of an edge of the larger structure, but rather are located entirely within the body of the larger structure.

As used herein, the term “removable element” should be understood to refer to, generally, a portion of a larger structure that is configured to be removable from the larger structure. In various embodiments, break-off elements and punch-out elements are two types of removable elements.

The present disclosure relates to a wearable personal accessory such as, for example, a wrist bracelet that includes a plurality of removable elements. Such a bracelet can be used to aid a person in the formation of a habit as shown in the illustrations and described below. When so used, for the purposes of this disclosure, such a bracelet will be referred to as “a habit bracelet.”

FIG. 11 shows an embodiment of a habit bracelet 10 with forty-two triangular break-off elements 12 and 15.

In an embodiment, the habit bracelet 10 comprises a band of a flexible material such as, for example, silicone or rubber, fabricated as a continuous loop. The habit bracelet 10 has a bottom edge 11 and a top edge 14. In the illustrated embodiment, there are twenty-one triangular break-off elements 12 adjacent to the bottom edge 11 of the habit bracelet 10 that can be broken off 13 by a user. In the illustrated embodiment, there are twenty-one triangular break-off elements 15 adjacent to the top edge 11 of the habit bracelet 10 that can be broken off by a user. (not shown.) Note that the habit bracelet 10 is fabricated such that break-off elements 12 and 15 are not just pictures, but are pre-scored.

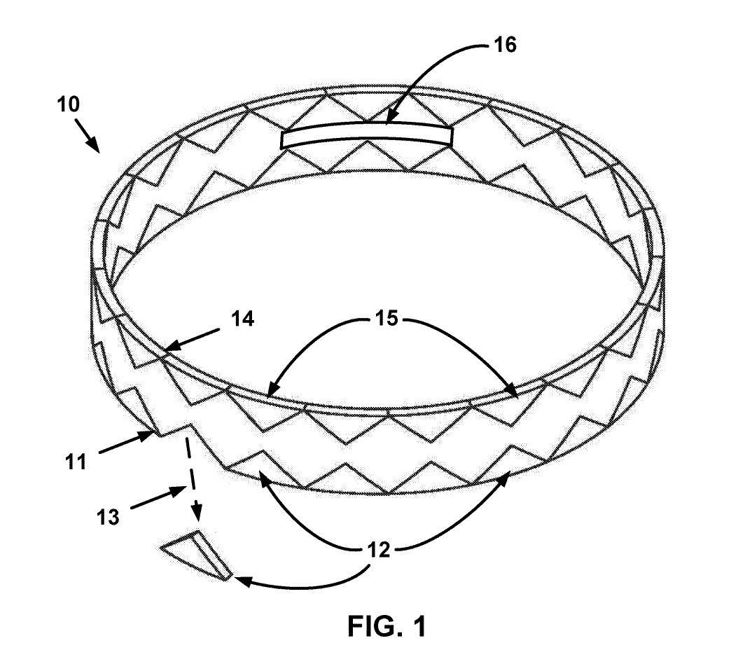

To use the habit bracelet 10 shown in FIG. 1, a user selects a targeted behavior for which the user wishes to form a habit. The user then stretches the habit bracelet 10 over a hand of the user and onto a wrist of the user. When the user performs the targeted behavior, the user breaks off 13 one of the break-off elements 12 and 15. In an exemplary use, the user performs the targeted behavior once per day, breaking off one break-off element per day, until all forty-two break-off elements 12 and 15 have been broken off from the habit bracelet 10. In the illustrated embodiment, this would correspond to a six week period.

In an embodiment, use the habit bracelet 10 shown in FIG. 1, has a rectangular space 16 inside the bracelet where a user can write, for example, with permanent marker, what habit is they they are trying to make or break. In an embodiment, the rectangle's texture is such that the writing would not run off. In an embodiment, a preprinted habit may be printed in place of the rectangular space and the user can wear the bracelet with the written portion visible or hidden

In various embodiments, a habit bracelet 10 could have more or fewer break-off elements than the embodiment shown in FIG. 1, for example twenty-one break-off elements corresponding to a three week period, or sixty-six break-off elements corresponding to a roughly 9½ week period.

In the illustrated embodiment, the habit bracelet 10 can still be worn after all of the break-off elements 12 and 15 have been removed from the bracelet. In various other embodiments, the habit bracelet 10 could be fabricated as a strip of flexible material, such as, for example, silicone or rubber, closable into a loop by a buckle attached to the strip (not shown.) In various embodiments, the habit bracelet could be manufactured from materials that are rigid or do not stretch such as, for example, metal or leather.

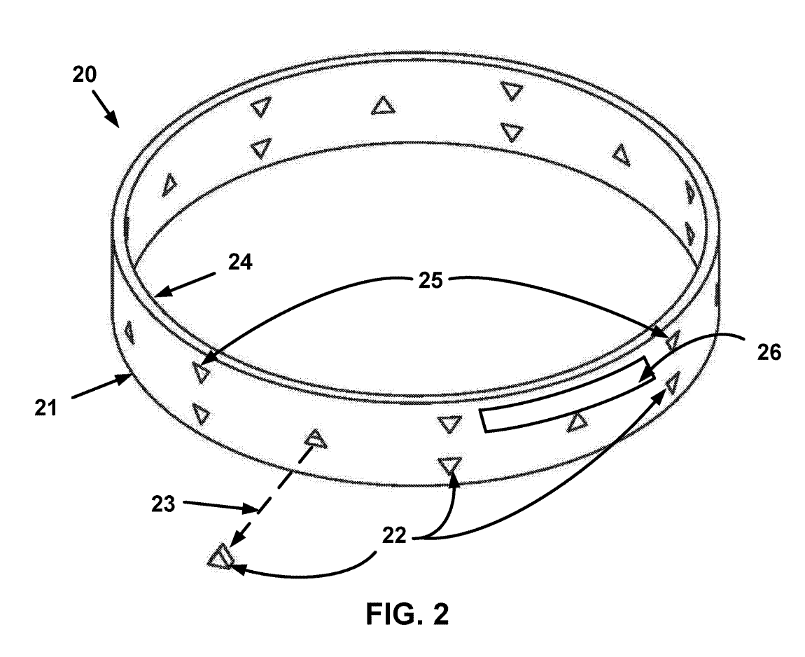

FIG. 2 shows an embodiment of the habit bracelet 20 with twenty-one triangular punch-out elements 22 and 25.

In an embodiment, the habit bracelet 20 comprises a band of a flexible material such as, for example, silicone or rubber, fabricated as a continuous loop. The bracelet 20 has a bottom edge 21 and a top edge 24. In the illustrated embodiment, the habit bracelet 20 additionally comprises twenty-one punch-out elements 22 and 25 that can be pushed out 23 by a user. Note that the habit bracelet 20 is fabricated such that punch-out elements 22 and 25 are not just pictures, but are pre-punched.

To use the habit bracelet 20 shown in FIG. 2, a user selects a targeted behavior for which the user wishes to form a habit. The user then stretches the bracelet 20 over a hand of the user and onto a wrist of the user. When the user performs the targeted behavior, the user pushes out 23 one of the punch-out elements 22 and, in an exemplary use, the user performs the targeted behavior once per day, pushing out one punch-out element per day, until all twenty-one punch-out elements 22 and 25 have been pushed out from the bracelet 20. In the illustrated embodiment, this would correspond to a three week period.

In an embodiment, the habit bracelet 20 shown in FIG. 2, has a rectangular space 26 outside the bracelet where a user can write, for example, with permanent marker, what habit it is that the user is trying to make or break. In an embodiment, the rectangle's texture is such that the writing would not run off. In an embodiment, a preprinted habit may be printed in place of the rectangular space.

In various embodiments, a habit bracelet could have more or fewer punch-out elements than the embodiment shown in FIG. 2, for example forty-two punch-out elements corresponding to a six week period, or sixty-six punch-out elements corresponding to a roughly 9½ week period.

In the illustrated embodiment, the habit bracelet 20 can still be worn after all of the punch-out elements 22 and 25 have been removed from the bracelet.

In various other embodiments, the habit bracelet 10 could be fabricated as a strip of flexible material that is closed into a loop using a buckle (not shown) to make it easier to take the bracelet on and off. In various embodiments, the habit bracelet could be manufactured from materials that are rigid or do not stretch such as, for example, metal or leather.

In various embodiments, habit bracelets, for example those shown in FIG. 1 and FIG. 2, can be manufactured in various colors and with various shapes of removable elements. In an embodiment, habit bracelets could be manufactured with both break-off and punch-out elements.

In various embodiments, habit bracelets could be manufactured in sizes configured to fit around the wrist of adults and children. In various other embodiments, habit bracelets could be manufactured in a sizes configured to fit around the ankle of adults and children (i.e. for use as an ankle bracelet). Providing habit bracelets manufactured for use as ankle bracelets may be highly desirable for some users, for example, a businessman in a suit, who would prefer to wear the bracelet less conspicuously.

In various embodiments, habit bracelets are low in cost to manufacture and can be sold with a several-hundred-percent markup in packs of five to ten bracelets of varying colors and punch-out and/or break-off shapes.

In various embodiments, bracelets can have a preprinted habit (exercise, dieting, etc.) in an embodiment. Consumers can request bulk creations of bracelets with a user-specified preprinted habit. In an embodiment, the habit bracelets of the present disclosure include a tool removably attached to the bracelets that can be used to assist in the removal of the shapes.

People love to be motivated. We all have things that can be improved in our lives through creation of habits whether they be weight loss and exercising more, abstinence, being a better parent, waking up on time, daily reading, prayer, doing an act of service, being kind to a sibling or co-worker, or brushing or flossing teeth (dentists can give them to their patients!); the possibilities are limitless.

The habit bracelets of the present disclosure can be used as motivational bracelets that help kids and adults make any kind goal and stick with it. The bracelets serve as a reminder for the user to keep working on the goal and track the user's progress as they go. For a user to be able to punch-out a shape or break-off a triangle every day and see the results of their effort may help the user stay motivated. Once users have formed a new habit, they will have a stylish bracelet that can be continually worn as a constant reminder of what they have accomplished.

In various other uses, punching out a shape or breaking off a break-off element could correspond with the number of times a certain activity is done. So it wouldn't necessarily need to be punched out daily, but could be punched out once something has been completed. So it could be given to a child to wear. When the child does something kind or above and beyond, a parent could say ‘okay, punch out one star.’ Once all of the stars are removed, the child could then get some sort of reward (like a date with the parent, a toy, ice cream, etc.). The bracelet would, in this case, act as a motivator and reminder.

In yet other uses, the habit bracelet could be used to countdown to an event or mark time on a calendar. For example, the habit bracelet could be used to track a Lenten or Advent calendar, or countdown to graduation day.

Embodiments of the habit bracelets disclosed herein fabricated from rubber or silicone can be worn at any time—even during showers or swimming—and can be a constant reminder to the wearer of the goals made.

The habit bracelets of the present disclosure have a high appeal especially as impulse purchases in a store checkout line, corner drugstores, health-food stores, gyms and fitness centers, weight loss centers, and gas stations.

In the foregoing specification, the disclosure has been described with reference to specific exemplary embodiments thereof. It will be evident that various modifications may be made thereto without departing from the broader spirit and scope as set forth in the following claims. For example, other types of wearable personal accessories such as, for example, necklaces, ankle bracelets (which can be very appealing to users who need to maintain a “dressed up” appearance), and belts could be manufactured with removable elements and be used for the formation of habits in a manner similar to that described above for the habit bracelets of FIG. 11 and FIG. 2. The specification and drawings are, accordingly, to be regarded in an illustrative sense rather than a restrictive sense.

1. A habit bracelet comprising:
a band fabricated from a flexible material having a top edge and a bottom edge, wherein the band has a plurality of removable elements.

2. The habit bracelet of claim 1 wherein a least a first portion of the plurality of removable elements comprises a first plurality of break-off elements adjacent to the bottom edge of the band.

3. The habit bracelet of claim 2 wherein a least a second portion of the plurality of removable elements comprises a second plurality of break-off elements adjacent to the top edge of the band.

4. The habit bracelet of claim 3 wherein the each of the first plurality of break-off elements and each of the second plurality of break-off elements has a shape selected from the group: triangular, square, rectangular, circular, semicircular, pentagonal, trapezoidal, star-shaped, and heart-shaped.

5. The habit bracelet of claim 4 wherein the band is fabricated as a continuous loop.

6. The habit bracelet of claim 5 wherein the band is fabricated in a size to fit around one of: a wrist of an adult, a wrist of a child, an ankle of an adult, and an ankle of a child.

7. The habit bracelet of claim 6 wherein the flexible material is one of: rubber, silicon.

8. The habit bracelet of claim 7 wherein the first plurality of break-off elements and the second plurality of break-off elements in total comprise one of: 21 break-off elements, 42 break-off elements or 66 break-off elements.

9. The habit bracelet of claim 4 wherein the band is a strip closable into a loop by a buckle attached to the strip.

10. The habit bracelet of claim 1 wherein a least a first portion of the plurality of removable elements comprises a plurality of punch-out elements.

11. The habit bracelet of claim 10 wherein the each of the plurality of punch-out elements has a shape selected from the group: triangular, square, rectangular, circular, semicircular, pentagonal, trapezoidal, star-shaped, and heart-shaped.

12. The habit bracelet of claim 11 wherein the band is fabricated as a continuous loop.

13. The habit bracelet of claim 12 wherein the band is fabricated in a size to fit around one of: a wrist of an adult, a wrist of a child, an ankle of an adult, and an ankle of a child.

14. The habit bracelet of claim 13 wherein the flexible material is one of: rubber, silicon.

15. The habit bracelet of claim 14 wherein the plurality of punch-out elements in total comprise one of: 21 punch-out elements, 42 punch-out elements or 66 punch-out elements.

16. The habit bracelet of claim 11 wherein the band is a strip closable into a loop by a buckle attached to the strip.

17. The habit bracelet of claim 10 wherein a least a second portion of the plurality of removable elements comprises a plurality of break-off elements.

18. The habit bracelet of claim 1 additionally comprising a textured rectangular space on the on one of: an inside of the band and an outside of the band, enabling a user to write a targeted behavior on the band.

19. The habit bracelet of claim 1 additionally comprising a preprinted targeted behavior on the on one of: an inside of the band and an outside of the band.

20. A method comprising:
selecting, by a person, a targeted behavior;
wearing, by the person, a bracelet, the bracelet comprising a plurality of removable elements;
performing, by the person, the targeted behavior; and
removing, by the person, one of the plurality of removable elements from the bracelet;
wherein the performing and removing steps are performed once per day until all of the plurality of removable elements have been removed from the bracelet.
